(19) United States
(12) Patent Application Publication
(10) Pub. No.: US 2025/0278661 A1
(43) Pub. Date: Sep. 4, 2025

(54) SAMPLING METHOD AND RELATED DEVICE FOR QUANTUM NEURAL NETWORK STRUCTURE OPTIMIZATION

(71) Applicant: YANGTZE DELTA INDUSTRIAL INNOVATION CENTER OF QUANTUM SCIENCE AND TECHNOLOGY, Suzhou (CN)

(72) Inventors: Tian LUAN, Suzhou (CN); Zaichen ZHANG, Suzhou (CN); Xutao YU, Suzhou (CN); Yuxiang LIU, Suzhou (CN); Fanxu MENG, Suzhou (CN); Baojun LU, Suzhou (CN); Bo FAN, Suzhou (CN)

(21) Appl. No.: 18/826,189

(22) Filed: Sep. 6, 2024

Related U.S. Application Data
(63) Continuation of application No. PCT/CN2023/134309, filed on Nov. 27, 2023.

(30) Foreign Application Priority Data
Dec. 21, 2022 (CN) 202211647142.8

(51) Int. Cl. G06N 10/60

(52) U.S. Cl. CPC G06N 10/60

(57) ABSTRACT

The application discloses a sampling method and a related device for quantum neural network structure optimization, which are applied to the technical field of quantum neural networks and include the following steps: initializing the structural parameters and constraint vectors of a quantum computer; sampling in the constraint vector according to the constraint vector and a constraint rule to construct a quantum gate sublayer; constructing a single-layer quantum neural network structure according to the quantum gate sublayer until the number of the single-layer quantum neural network structure layers reaches a specified value to form a quantum neural network structure; and outputting the quantum neural network structure. The single-layer quantum neural network structure can be automatically sampled through the constraint vector and the constraint rule, until the final quantum neural network structure is generated, and the automatic quantum neural network sampling can be realized.

### CROSS-REFERENCE TO RELATED APPLICATIONS

The present application is a continuation of International Application No. PCT/CN2023/134309, with an international filing date of Nov. 27, 2023, which is based upon and claims priority to Chinese Patent Application No. 202211647142.8, filed on Dec. 21, 2022, the entire contents of all of which are incorporated herein by reference.

### TECHNICAL FIELD

The present disclosure relates to a technical field of quantum neural network, and particularly to a sampling method for quantum neural network structure optimization, a sampling device for quantum neural network structure optimization, a sampling apparatus for quantum neural network structure optimization, and a computer-readable storage medium.

### BACKGROUND

Quantum neural network is a parameter-containing quantum circuit implemented on a Noisy-Intermediate-Scale Quantum (NISQ) device. The parameters of the quantum neural network mainly act on a parameter-containing quantum gate in the circuit. The purpose of training a quantum neural network is to generate quantum states to minimize the cost function by adjusting the parameters of the quantum neural network. However, since quantum bits and quantum gates are affected by noise, the cost function is difficult to reach an exact minimum after the training of a neural network. The quantum neural network structure optimization dynamically adjusts the structure of the quantum neural network by sampling and evaluating the structure of the quantum neural network to mitigate the influence of noise in the training of the quantum neural network. Moreover, the sampling of the quantum neural network structure is an indispensable step in the quantum neural network structure optimization.

The feasibility of the sampling of the quantum neural network structure is verified theoretically and experimentally at the present stage, which provides a strong guarantee for the quantum neural network structure optimization and the training of the quantum neural network. Accordingly, it is an urgent problem to be solved by those skilled in the art to provide a convenient and feasible sampling solution for quantum neural network.

### SUMMARY

The object of the present disclosure is to provide a sampling method for quantum neural network structure optimization, which can realize automatic quantum neural network sampling. A further object of the present disclosure is to provide a sampling device for quantum neural network structure optimization, a sampling apparatus for quantum neural network structure optimization, and a computer-readable storage medium, which can realize automatic quantum neural network sampling.

To solve the above technical problem, the present disclosure provides a sampling method for quantum neural network structure optimization, comprising the steps of:
initializing structural parameters and constraint vectors of a quantum computer;
sampling in the constraint vector according to the constraint vector and a constraint rule to construct a quantum gate sublayer;
constructing a single-layer quantum neural network structure according to the quantum gate sublayer until the number of the single-layer quantum neural network structure layers reaches a specified value to form a quantum neural network structure; and
outputting the quantum neural network structure.

Optionally, the step of initializing structural parameters and constraint vectors of a quantum computer comprises:
initializing the number of quantum bit, a list of feasible CNOT gates, and an initial quantum state; and
initializing constraint vectors.

Optionally, the step of initializing constraint vectors comprises:
initializing permission vectors of a Pauli Y revolving gate;
initializing permission vectors of a Pauli Z revolving gate; and
initializing permission vectors of a CNOT gate.

Optionally, the step of constructing a single-layer quantum neural network structure according to the quantum gate sublayer until the number of the single-layer quantum neural network structure layers reaches a specified value to form a quantum neural network structure comprises:
constructing a single-layer quantum neural network structure according to the quantum gate sublayer; and
updating the constraint vector after each single-layer quantum neural network structure is constructed, so as to update the quantum gate sublayer in a next computation round according to the updated constraint vector, and to construct a next single-layer quantum neural network structure according to the updated quantum gate sublayer until the number of the single-layer quantum neural network structure layers reaches a specified value to form a quantum neural network structure.

Optionally, the step of sampling in the constraint vector according to the constraint vector and a constraint rule to construct a quantum gate sublayer comprises:
sampling according to the permission vectors of a Pauli Y revolving gate and the permission vectors of a Pauli Z revolving gate, to construct a single-bit gate sublayer;
updating the permission vectors of a CNOT gate according to the single-bit gate sublayer;
sampling according to the updated permission vectors of a CNOT gate to construct a CNOT gate sublayer;
the step of constructing a single-layer quantum neural network structure according to the quantum gate sublayer comprises:
constructing a single-layer quantum neural network structure according to the single- bit gate sublayer and the CNOT gate sublayer.

Optionally, the step of updating the constraint vector after each single-layer quantum neural network structure is constructed comprises:
updating the permission vectors of a Pauli Y revolving gate, the permission vectors of a Pauli Z revolving gate, and the permission vectors of a CNOT gate after each single-layer quantum neural network structure is constructed.

Optionally, the step of initializing structural parameters and constraint vectors of a quantum computer comprises:
initializing a resultant quantum neural network structure as an empty list;
after sampling in the constraint vector according to the constraint vector and a constraint rule to construct a quantum gate sublayer, the step further comprises:
adding the constructed single-layer quantum neural network structure to the resultant quantum neural network structure; and
the step of outputting the quantum neural network structure comprises:
outputting the resultant quantum neural network structure.

The present disclosure further provides a sampling device for quantum neural network structure optimization, comprising:
an initialization module for initializing structural parameters and constraint vectors of a quantum computer;
a quantum gate sublayer module for sampling in the constraint vector according to the constraint vector and a constraint rule to construct a quantum gate sublayer;
a single-layer quantum neural network structure module for constructing a single-layer quantum neural network structure according to the quantum gate sublayer until the number of the single-layer quantum neural network structure layers reaches a specified value to form a quantum neural network structure; and
an output module for outputting the quantum neural network structure.

The present disclosure further provides a sampling apparatus for quantum neural network structure optimization, comprising:
a memory for storing computer program; and
a processor for implementing the steps of a sampling method for quantum neural network structure optimization as described previously when executing the computer program.

The present disclosure further provides a computer-readable storage medium which has a computer program stored thereon, the computer program being executed by a processor to implement the steps of a sampling method for quantum neural network structure optimization as described previously.

A sampling method for quantum neural network structure optimization provided by the present disclosure comprises the steps of: initializing the structural parameters and constraint vectors of a quantum computer; sampling in the constraint vector according to the constraint vector and a constraint rule to construct a quantum gate sublayer; constructing a single-layer quantum neural network structure according to the quantum gate sublayer until the number of the single-layer quantum neural network structure layers reaches a specified value to form a quantum neural network structure; and outputting the quantum neural network structure.

The single-layer quantum neural network structure can be automatically sampled through the constraint vector and the constraint rule, until the final quantum neural network structure is generated, and the automatic quantum neural network sampling can be realized.

The present disclosure further provides a sampling device for quantum neural network structure optimization, a sampling apparatus for quantum neural network structure optimization, and a computer-readable storage medium, which can achieve the above advantageous effects, and thus it will not be described in detail herein.

### BRIEF DESCRIPTION OF THE DRAWINGS

In order to more clearly explain the technical solutions in the embodiments of the present disclosure or the prior art, drawings required in the embodiments or the prior art will be briefly described below. Obviously, the drawings in the following description are some embodiments of the present disclosure. For those skilled in the art, other drawings may be obtained from these drawings without any creative effort.

FIG. 1 is a flow diagram of a sampling method for quantum neural network structure optimization according to the embodiments of the present disclosure;

FIG. 2 is a flow diagram of a specific sampling method for quantum neural network structure optimization according to the embodiments of the present disclosure;

FIG. 3 is a quantum circuit corresponding to the output resultant quantum neural network structure according to the embodiments of the present disclosure;

FIG. 4 is a structure diagram of a sampling device for quantum neural network structure optimization according to the embodiments of the present disclosure;

FIG. 5 is a structure diagram of a sampling apparatus for quantum neural network structure optimization according to the embodiments of the present disclosure.

### DETAILED DESCRIPTION OF THE EMBODIMENTS

The core of the present disclosure is to provide a sampling method for quantum neural network structure optimization. The feasibility of the sampling of the quantum neural network structure is verified theoretically and experimentally in the prior art.

However, the sampling method for quantum neural network structure optimization provided by the present disclosure comprises the steps of: initializing the structural parameters and constraint vectors of a quantum computer; sampling in the constraint vector according to the constraint vector and a constraint rule to construct a quantum gate sublayer; constructing a single-layer quantum neural network structure according to the quantum gate sublayer until the number of the single-layer quantum neural network structure layers reaches a specified value to form a quantum neural network structure; and outputting the quantum neural network structure.

The single-layer quantum neural network structure can be automatically sampled through the constraint vector and the constraint rule, until the final quantum neural network structure is generated, and the automatic quantum neural network sampling can be realized.

In order to enable those skilled in the art to better understand the aspects of the present disclosure, the present disclosure will now be described in further detail with reference to the accompanying drawings and detailed description. Obviously, the described embodiments are part of, but not all of, the embodiments of the present disclosure. Based on the embodiments of the present disclosure, all the other embodiments obtained by those skilled in the art without paying any creative work fall within the protection scope of the present disclosure.

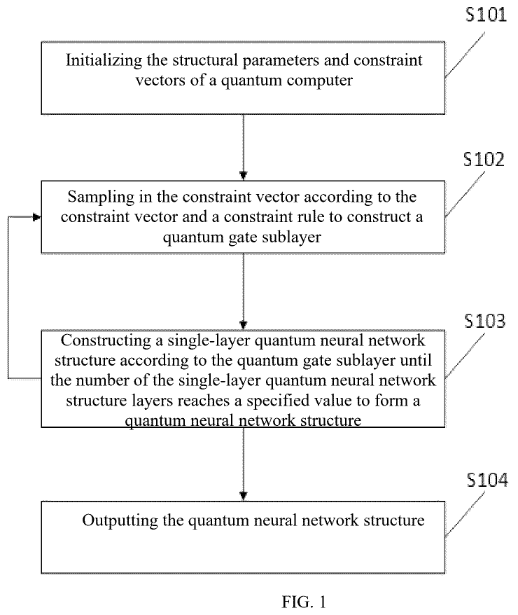

With reference to FIG. 1, FIG. 1 is a flow diagram of a sampling method for quantum neural network structure optimization according to the embodiments of the present disclosure.

Referring to FIG. 1, in the embodiments of the present disclosure, a sampling method for quantum neural network structure optimization comprises the steps of:
S101: initializing the structural parameters and constraint vectors of a quantum computer.

In the step, it is necessary to initialize structural parameters and constraint vectors of a quantum computer according to the actual structure of a quantum computer. The above structural parameters may specifically include the number of quantum bit, a list of feasible CNOT gates, and an initial quantum state. The corresponding step may comprise initializing the number of quantum bit, a list of feasible CNOT gates, and an initial quantum state; and initializing constraint vectors.

In the embodiments of the present disclosure, the step of initializing constraint vectors comprises: initializing permission vectors of a Pauli Y revolving gate; initializing permission vectors of a Pauli Z revolving gate; and initializing permission vectors of a CNOT gate. In other words, in the embodiments of the present disclosure, three vectors, namely, permission vectors of a Pauli Y revolving gate, permission vectors of a Pauli Z revolving gate, and permission vectors of a CNOT gate, will be specifically used as constraint vectors. The specific contents of the constraint vectors will be described in detail in the following embodiments of the present disclosure and will not be described in detail herein.
S102: sampling in the constraint vector according to the constraint vector and a constraint rule to construct a quantum gate sublayer.

In the step, a quantum gate sublayer is constructed according to the above constraint vector and a constraint rule, and the above sampling process is generally an uniform sampling. The specific contents of the quantum gate layer will be described in detail in the following embodiments of the present disclosure and will not be described in detail herein.
S103: constructing a single-layer quantum neural network structure according to the quantum gate sublayer until the number of the single-layer quantum neural network structure layers reaches a specified value to form a quantum neural network structure.

In the step, a single-layer quantum neural network structure is constructed according to the quantum gate sublayer, and in general, each single-layer quantum neural network structure is constructed layer by layer until the number of the single-layer quantum neural network structure layers reaches a specified value, so that the sampling of the quantum neural network structure is completed, and the quantum neural network structure is formed.

Usually, the step specifically comprises: constructing a single-layer quantum neural network structure according to the quantum gate sublayer; and updating the constraint vector after each single-layer quantum neural network structure is constructed, so as to update the quantum gate sublayer in a next computation round according to the updated constraint vector, and to construct a next single-layer quantum neural network structure according to the updated quantum gate sublayer until the number of the single-layer quantum neural network structure layers reaches a specified value to form a quantum neural network structure.

In other words, a single-layer quantum neural network structure is constructed according to the current quantum gate sublayer in one calculation round. Then, the above constraint vectors will be updated to construct a new quantum gate sublayer in the next computation round, i.e., updating the quantum gate sublayer. A next single-layer quantum neural network structure is constructed according to the updated quantum gate sublayer. The above process is repeated, and the construction of the whole quantum neural network structure can be realized along with the advancement of computation rounds. The specific contents of the step will be described in detail in the following embodiments of the present disclosure and will not be described in detail herein.
S104: outputting the quantum neural network structure.

In the step, the quantum neural network structure constructed by the above sampling is output, so as to perform subsequent operation based on the quantum neural network structure.

The present disclosure provides a sampling method for quantum neural network structure optimization. The single-layer quantum neural network structure can be automatically sampled through the constraint vector and the constraint rule, until the final quantum neural network structure is generated, and the automatic quantum neural network sampling can be realized.

The specific contents of the sampling method for quantum neural network structure optimization will be described in detail in the following embodiments of the present disclosure.

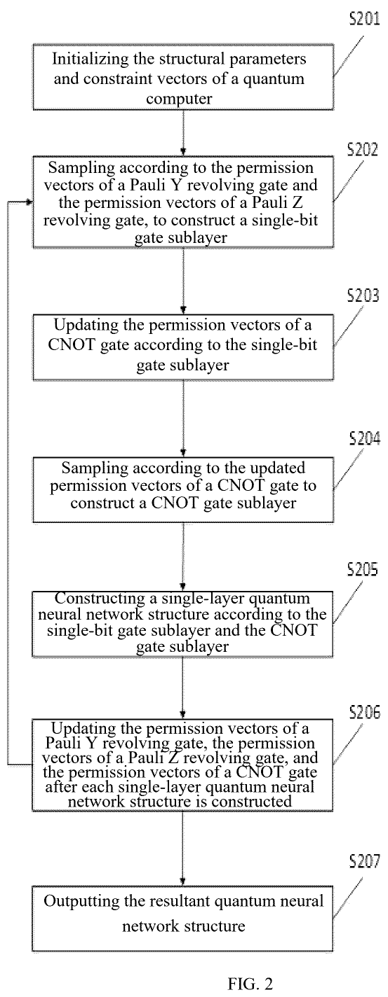

With reference to FIG. 2, FIG. 2 is a flow diagram of a specific sampling method for quantum neural network structure optimization according to the embodiments of the present disclosure.

Referring to FIG. 2, in the embodiments of the present disclosure, a sampling method for quantum neural network structure optimization comprises the steps of:
S201: initializing the structural parameters and constraint vectors of a quantum computer.

Specific structural parameters that will be initialized in the embodiments of the present disclosure include the number of quantum bit Q, a list of feasible CNOT gates C, and an initial quantum state. The initializing constraint vectors comprises: permission vectors of a Pauli Y revolving gate, permission vectors of a Pauli Z revolving gate, and permission vectors of a CNOT gate.

The specific step of initializing the constraint vectors comprises:
initializing permission vectors of a Pauli Y revolving gate (Ry) p_{y}=[p_{y,1}, p_{y,2}, . . . , p_{y,Q}], wherein regarding any i∈={1,2, . . . Q}, p_{y,i}=1;
initializing permission vectors of a Pauli Z revolving gate (Rz) p_{z}=[P_{z,1}, P_{z,2}, . . . , p_{z,Q}], wherein regarding any i∈{1,2, . . . Q}, if the initial quantum state of the ith quantum bit is (0 [symbol] , p_{z,i}=0, otherwise, p_{z,i}=1; and
initializing permission vectors of a CNOT gate p_{cx}=[p_{cx,1}, p_{cx,2}, . . . , P_{cx,T}], wherein T is the size of c, regarding any i∈{1,2, . . . , Q}, if the initial quantum state corresponding to the control bit of the ith feasible CNOT gate is |0 [symbol] , p_{cx,i}=−1, otherwise, p_{cx,i}=1.
S202: sampling according to the permission vectors of a Pauli Y revolving gate and the permission vectors of a Pauli Z revolving gate, to construct a single-bit gate sublayer.

In the step, a single-bit gate sublayer by Lₛ=[L_{s,1}, L_{s,2}, . . . , L_{s,Q}] used will be constructed according to the permission vectors of a Pauli Y revolving gate P_{y} and permission vectors of a Pauli Z revolving gate p_{z}.

Specifically, in the step, a single-bit gate sublayer is set as Lₛ=[L_{s,1}, L_{s,2}, . . . , L_{s,Q}], wherein, regarding any i∈{1,2, . . . , Q}, L_{s,1} indicates the type of a single-bit quantum gate acting on the ith quantum bit. The candidate set may be set as:

$$E \text{?} = \{ \begin{matrix}( I , {R}_{x} , {R}_{y} ) , & {p}_{y ,} \text{?} = 1 , {p}_{z ,} \text{?} = 1 \\ ( I , {R}_{y} ) , & {p}_{y ,} \text{?} = 1 , {p}_{y ,} \text{?} = 0 \\ ( I , {R}_{z} ) & {p}_{y ,} \text{?} = 0 , {p}_{z ,} \text{?} = 1 \\ ( I ) , & Others\end{matrix}$$

$$\text{?} \text{indicates text missing or illegible when filed}$$

Regarding any i∈{1,2, . . . , Q}, an uniform sampling is carried out in the candidate set E_{s,i} to obtain the type of the single-bit quantum gate of the ith quantum bit L_{z,1}, and finally the single-bit gate sublayer is obtained.
S203: updating the permission vectors of a CNOT gate according to the single-bit gate sublayer.

In the step, the permission vectors of a CNOT gate will be updated according to the single-bit gate sublayer, which specifically comprises:

Regarding any i∈{1,2, ... , Q}, if the control bit of the ith feasible CNOT gate is the jth quantum bit and L_{s,j}=R_{y}, p_{cx,i}=1, otherwise, P_{cx,i} is unchanged; if the controlled bit of the ith feasible CNOT gate is the kth quantum bit and L_{s,k}=R_{y}, p_{cx,i}1, otherwise, it is unchanged; and if L_{s,k}=Rz and P_{cx,i}=0 before update, P_{cx,i}=1 after update, otherwise, it is unchanged.
S204: sampling according to the updated permission vectors of a CNOT gate to construct a CNOT gate sublayer.

In the step, a CNOT gate sublayer L_{cx} is constructed according to the updated permission vectors of a CNOT gate p_{cx}. Specifically, the candidate CNOT set C_{c}={Cᵢ|p_{cx,i}=1} is first defined, wherein Cᵢ is the ith feasible CNOT gate. A set of feasible CNOT sublayer structures A_{cx}={{C|C∈C_{c}}| Any Cᵢ, Cⱼnon-sharing quantum bits} is constructed. An uniform sampling is conducted randomly in A_{cx} to obtain a set L_{cx}, i.e., constructing a CNOT gate sublayer L_{cx}.
S205: constructing a single-layer quantum neural network structure according to the single-bit gate sublayer and the CNOT gate sublayer.

In the step, a single-layer quantum neural network structure L=(Lₛ, L_{cx}) is constructed according to the single-bit gate sublayer Lₛ and the CNOT gate sublayer L_{cx}.
S206: updating the permission vectors of a Pauli Y revolving gate, the permission vectors of a Pauli Z revolving gate, and the permission vectors of a CNOT gate after each single-layer quantum neural network structure is constructed.

The above method for updating the permission vectors of a Pauli Y revolving gate p_{y} is as follows:

Regarding any i∈{1,2, . . . , Q}, if L_{s,i}≠R_{z} and [symbol] C∈L_{cx}, the control bit or controlled bit of C is the ith quantum bit, p_{y,i}=0, otherwise, p_{y,i}=1.

The above method for updating the permission vectors of a Pauli Z revolving gate p_{z} is as follows:

Regarding any i∈{1,2, . . . , Q}, if L_{s,i}≠R_{y} and [symbol] C∈L_{cx}, the controlled bit of C is the ith quantum bit, P_{z,i}=0, otherwise, p_{z,i}=1.

The above method for updating the permission vectors of a CNOT gate p_{cx} is as follows:

Regarding any i∈{1,2, . . . , T}, the control bit and the controlled bit of the ith feasible CNOT gate Cᵢ can be set as the jth and kth quantum bit, respectively, if Cᵢ∈L_{cx}, p_{cx,i}=0; otherwise, P_{cx,i} is unchanged; if p_{cx,i}−1, L_{s,j}=R_{y} or ∃C∈L_{cx}, wherein the controlled bit of C is the jth quantum bit, p_{cx,i}=1; if p_{cx,i}=0, if L_{s,j}=R_{y}, or L_{s,k}≠1, or ∃C∈L_{cx}, wherein the control bit of is the jth quantum bit or the controlled bit of is the jth or kth quantum bit, p_{cx,i}=1; otherwise, P_{cx,i} is unchanged.

After this step, it is necessary to return to the above S202, and repeat the above S202 to S206 until the number of the single-layer quantum neural network structure layers reaches a specified value to form a quantum neural network structure.

Specifically, the above S201 may further include initializing a resultant quantum neural network structure as an empty list.

In other words, a resultant quantum neural network structure is initialized as an empty list R=[], and then the generated single-layer quantum neural network structure is added to the list R until the resultant quantum neural network structure is generated.

Accordingly, after the above S205, the constructed single-layer quantum neural network structure may be further added to the resultant quantum neural network structure. The process of adding the single-layer quantum neural network structure to the list R specifically comprises: first, setting the current length of the list R as l, i.e., R=[L₁, L₂, . . . , Lₗ], and then adding the single-layer quantum neural network structure L to the end of the list R, i.e., R=[L₁, L₂, . . . , Lₗ, L].
S207: outputting the resultant quantum neural network structure.

The step is basically the same as S104 in the above embodiment of the present disclosure. The step specifically comprises outputting the resultant quantum neural network structure. Regarding the rest of contents, please refer to the above embodiment of the present disclosure for details, and it will not be repeated herein.

The present disclosure provides a sampling method for quantum neural network structure optimization. The single-layer quantum neural network structure can be automatically sampled through the constraint vector and the constraint rule, until the final quantum neural network structure is generated, and the automatic quantum neural network sampling can be realized. The specific contents of the sampling method for quantum neural network structure optimization will be described in detail in the following embodiments of the present disclosure.

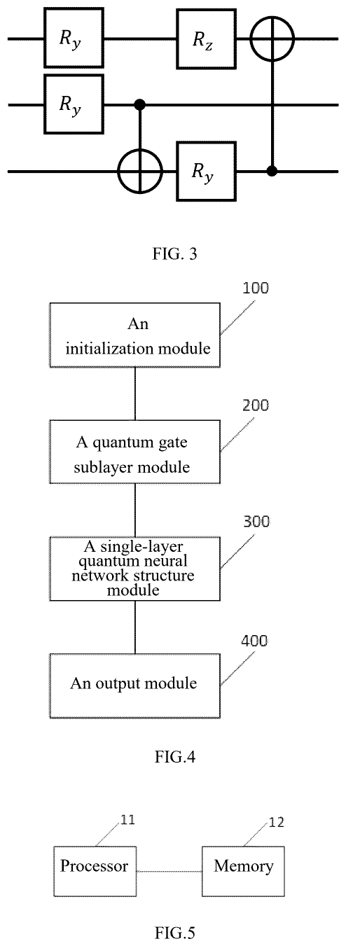

With reference to FIG. 3, FIG. 3 is a quantum circuit corresponding to the output resultant quantum neural network structure according to the embodiments of the present disclosure.

In the embodiments of the present disclosure, the quantum circuit as shown in FIG. 3 is finally generated based on the method provided by the embodiment of the present disclosure, and the specific contents of the constraint rules thereof has been described in detail in the embodiments of the present disclosure and will not be described in detail herein. Referring to FIG. 3, the implementation of the present disclosure will be specifically described by extracting an example of a neural network structure with 3-quantum bits, a list of feasible CNOT gates C=[CNOT_{1.2}, CNOT_{2.3}, CNOT_{3.1}], an initial state |000 [symbol] , and maximum number of layers of 2, wherein CNOT_{i,j} represents a CNOT gate in which the control bit and controlled bit are the ith and jth quantum bits, respectively.

Step 1: arrange the number of quantum bits Q=3, a list of feasible CNOT gates C=[CNOT_{1.2}, CNOT_{2.3}, CNOT_{3.1}], and an initial quantum state |000 [symbol] .

Step 2: initialize the constraint vector: first, the Ry permission vector p_{y}=[1,1,1] is arranged. Since the initial state of all quantum bits is |0 [symbol] , the Rz permission vector pₓ=[0,0,0] and the permission vector of the CNOT gate p_{cx}=[−1, −1, −1] are initialized.

Step 3: initialize a resultant quantum neural network structure as an empty list R =[].

Steps 4 to 7: constantly extract the single-layer quantum neural network structure according to the constraint vectors and constraint rules, update the constraint vectors and add the extracted single-layer quantum neural network structure to the resultant quantum neural network until the number of the resultant quantum neural network structure layers reaches a specified value 2:

First, a single-bit gate sublayer Lₛ=[L_{s,1}, L_{s,2}, L_{s,3}] is constructed randomly. Regarding any i∈{1,2,3}, p_{y,i}=1 and p_{z,i}=0. Therefore, an uniform sampling is conducted in [l, R_{y}] to obtain L_{s,i}. Presuming that the sampling result is Lₛ=[R_{y}, R_{y}l].

According to Lₛ, since L_{s,1} and L_{s,2} are R_{y}, the permission vector values P_{cx,1} and p_{cx,2} corresponding to C₁ and C₂ should be updated to 1, i.e., updated to p_{cx}=[1,1, −1].

Therefore, C_{c}={C₁, C₂}, and further A_{cx}={{C₁}, {C₂}}. An uniform sampling is conducted in A_{cx} to obtain L_{cx}. Presuming that the sampling result is L_{cx}={C₂}, a single-layer quantum neural network structure L=(Lₛ, L_{cx})=([R_{y}, R_{y}, l], {C₂}) is obtained.

The constraint vector is updated according to L: since L_{s,1}≠R_{z} and [symbol] C∈L_{cx}, the control bit or controlled bit of C is the first quantum bit, p_{y,1}0; since the control bit of C₂ is the second quantum bit, p_{y,2}1; since the controlled bit of C₂ is the third quantum bit, p_{y,3}=1. Therefore, p_{y}=[0,1,1].

Since L_{s,1}=R_{y}, p_{z,1}=1; since L_{s,2}=R_{y}, P_{z,2}=1; since the controlled bit of C₂ is the third quantum bit, p_{z,3}=1. Therefore, p_{z}=[1,1,1].

Since C₂∈L_{cx}, p_{cx,2}=0; since L_{s,1}=R_{y}, P_{cx,1}=1; since the controlled bit of C₂ is the third quantum bit, and the control bit of C₃ is the third quantum bit, p_{cx,3}=1. Therefore, p_{cx}=[1,0,1]. Overall, the constraint vector is updated as:
p_{y}=[0,1,1], p_{z}=[1,1,1], p_{cx}=[1,0,1].

The single-layer quantum neural network structure L is added to the resultant quantum neural network structure to obtain a resultant quantum neural network structure with the layer number of 1 R=[([R_{y}, R_{y}, l], {C₂}) ]. Since the number of layers does not reach a specified value of 2, the above process shall be repeated.

A single-bit gate sublayer Lₛ=[L_{s,1}, L_{s,2}, L_{s,3}] is constructed randomly. Since p_{y,1}=0, p_{z,1}=1. Therefore, an uniform sampling is conducted in {I, R_{z}} to obtain L_{s,1}; since p_{y,2}=1, an uniform sampling is conducted in {I, R_{y}, Rₓ} to obtain L_{s,2}; since p_{y,3}=1, p_{z,3}=1, an uniform sampling is conducted in {I, R_{y}, R_{z}} to obtain L_{s,3}. Presuming that the sampling result is Lₛ=[R_{z}, l, R_{y}].

According to Lₛ, since L_{s,1} is R_{z}, p_{cx,3}=1; since L_{s,3} is R_{y}, p_{cx,1}=p_{cx,2}=1. Therefore, p_{cx}=[1,1,1] is updated.

Accordingly, C_{c}={C₁, C₂, C₃}, and further A_{cx}={{C₁}, {C₂}, {C₃}}. An uniform sampling is conducted in A_{cx} to obtain L_{cx}. Presuming that the sampling result is L_{cx}={C₃}, a single-layer quantum neural network structure L=(Lₛ, Lₛₓ)=( [R_{z}, I, R_{y}], {C₃}) is obtained.

The constraint vector is updated according to L: since L_{s,1}=R_{z} and the controlled bit of C₃ is the first quantum bit, p_{y,1}=1; since L_{s,2}≠Rₓ and [symbol] C∈L_{cx}, the control bit or the controlled bit of C is the second quantum bit, p_{y,2}=0; since the control bit of C₃; is the third quantum bit, p_{y,3}=1. Therefore, p_{y}=[1,0,1].

Since the controlled bit of C₃ is the first quantum bit, p_{z,1}=1; if L_{s,2}≠R_{y}, and [symbol] C∈L_{cx}, the controlled bit of C is the second quantum bit, p_{z,2}=0;since L_{s,3}=R_{y}, p_{z,3}=1. Therefore, p_{z}=[1,0,1].

Since C₃∈L_{cx}, p_{cx,3}=0; since the controlled bit of C₃ is the first quantum bit, p_{cx,1}=1; since C₂∈L_{cx} and P_{cx,2}=1, p_{cx,2} is unchanged. Therefore, p_{cx}=[1,1,0]. Overall, the constraint vector is updated as:
p_{y}=[1,0,1], p_{z}=[1,0,1], p_{cx}=[1,1,0].

The single-layer quantum neural network structure L is added to the resultant quantum neural network structure to obtain a resultant quantum neural network structure with the layer number of 2 R=[([R_{y}, R_{y}, I], {C₂}), (R_{z}, I, R_{y}], {C₃}) ]. Since the number of layers does not reach a specified value of 2, the above process shall be repeated.

Step 8: output the resultant quantum neural network structure:

R=[([R_{y}, R_{y}, I], {C₂}), ([R_{z}, I, R_{y}], {C₃}) ]. The quantum circuit thereof is shown in FIG. 3. A sampling device for quantum neural network structure optimization provided by the embodiments of the present disclosure is described below. The sampling device for quantum neural network structure optimization described below and the sampling method for quantum neural network structure optimization described above may be correspondingly referred to each other.

With reference to FIG. 4, FIG. 4 is a structure diagram of a sampling device for quantum neural network structure optimization according to the embodiments of the present disclosure. Referring to FIG. 4, a sampling device for quantum neural network structure optimization comprises:
an initialization module 100 for initializing structural parameters and constraint vectors of a quantum computer;
a quantum gate sublayer module 200 for sampling in the constraint vector according to the constraint vector and a constraint rule to construct a quantum gate sublayer;
a single-layer quantum neural network structure module 300 for constructing a single-layer quantum neural network structure according to the quantum gate sublayer until the number of the single-layer quantum neural network structure layers reaches a specified value to form a quantum neural network structure; and
an output module 400 for outputting the quantum neural network structure.

Preferably, in the embodiments of the present disclosure, an initialization module 100 comprises:
a structure initialization unit for initializing the number of quantum bit, a list of feasible CNOT gates, and an initial quantum state; and
a vector initialization unit for initializing constraint vectors.

Preferably, in the embodiments of the present disclosure, the structure initialization unit comprises:
a Y revolving gate permission vector subunit for initializing permission vectors of a Pauli Y revolving gate;
a Z revolving gate permission vector subunit for initializing permission vectors of a Pauli Z revolving gate; and
a CNOT gate permission vector subunit for initializing permission vectors of a CNOT gate.

Preferably, in the embodiments of the present disclosure, the single-layer quantum neural network structure module 300 comprises:
a single-layer quantum neural network structure subunit for constructing a single-layer quantum neural network structure according to the quantum gate sublayer; and
a constraint vector updating unit for updating the constraint vector after each single-layer quantum neural network structure is constructed, so as to update the quantum gate sublayer in a next computation round according to the updated constraint vector, and to construct a next single-layer quantum neural network structure according to the updated quantum gate sublayer until the number of the single-layer quantum neural network structure layers reaches a specified value to form a quantum neural network structure.

Preferably, in the embodiments of the present disclosure, the quantum gate sublayer module 200 comprises:
a single-bit gate sublayer subunit for sampling according to the permission vectors of a Pauli Y revolving gate and the permission vectors of a Pauli Z revolving gate, to construct a single-bit gate sublayer;
a CNOT gate permission vector updating unit for updating the permission vectors of a CNOT gate according to the single-bit gate sublayer; and
a CNOT gate sublayer unit for sampling according to the updated permission vectors of a CNOT gate to construct a CNOT gate sublayer.

The single-layer quantum neural network structure module 300 is specifically used for:
constructing a single-layer quantum neural network structure according to the single-bit gate sublayer and the CNOT gate sublayer.

Preferably, in the embodiments of the present disclosure, the constraint vector updating unit is specifically used for:
updating the permission vectors of a Pauli Y revolving gate, the permission vectors of a Pauli Z revolving gate, and the permission vectors of a CNOT gate after each single-layer quantum neural network structure is constructed.

Preferably, in the embodiments of the present disclosure, an initialization module 100 comprises:
a list initialization unit for initializing a resultant quantum neural network structure as an empty list;
further comprises:
an addition module for adding the constructed single-layer quantum neural network structure to the resultant quantum neural network structure;
an output module 400 is used for:
outputting the resultant quantum neural network structure.

The sampling device for quantum neural network structure optimization in the embodiment is used to implement the above sampling method for quantum neural network structure optimization. Therefore, the specific implementation of the sampling design module for quantum neural network structure optimization can be referred to the embodiment part of the sampling design method for quantum neural network structure optimization. For example, an initialization module 100, a quantum gate sublayer module 200, a single-layer quantum neural network structure module 300, and an output module 400 are used respectively for implementing steps S101 to S104 of the above sampling design method for quantum neural network structure optimization. Therefore, the embodiments thereof can be referred to the corresponding descriptions of the respective partial embodiments in the above context, and will not be described in detail herein.

A sampling apparatus for a quantum neural network structural optimization provided by the embodiment of the present disclosure is described below. The sampling apparatus for quantum neural network structure optimization described below and the sampling method for quantum neural network structure optimization and the sampling device for quantum neural network structure optimization described above may be correspondingly referred to each other.

With reference to FIG. 5, FIG. 5 is a structure diagram of a sampling apparatus for quantum neural network structure optimization according to the embodiments of the present disclosure.

Referring to FIG. 5, The sampling apparatus for quantum neural network structure optimization may comprise a processor 11 and a memory 12.

The memory 12 is used for storing computer program. The processor 11 is used for implementing the specific contents of a sampling method for quantum neural network structure optimization as claimed in the above embodiments of the present disclosure when executing the computer program.

The processor 11 in The sampling apparatus for quantum neural network structure optimization of the present embodiment is used to install the sampling device for quantum neural network structure optimization described in the above embodiments of the present disclosure, and at the same time, the processor 11 in combination with the memory 12 can realize the sampling method for quantum neural network structure optimization described in any of the above embodiments of the present disclosure. Therefore, the specific implementation of The sampling apparatus for quantum neural network structure optimization can be referred to the embodiment part of the sampling method for quantum neural network structure optimization. The embodiments thereof can be referred to the corresponding descriptions of the respective partial embodiments in the above context, and will not be described in detail herein.

The present disclosure further provides a computer-readable storage medium. The computer-readable storage medium has a computer program stored thereon, the computer program being executed by a processor to implement a sampling method for quantum neural network structure optimization as described in any of the above embodiments of the present disclosure. The rest of the contents can be referred to the prior art and will not be described herein without further development.

Each embodiment in the specification is described in a progressive manner, each embodiment focuses on the differences from other embodiments, and the same or similar parts among the embodiments can be referred to each other. For the device disclosed in the embodiments, the description thereof is relatively simple since it corresponds to the method disclosed in the embodiments. For the relevant information, please refer to the description of the method.

Those skilled in the art may further realize that the units and algorithmic steps of the examples described in conjunction with the embodiments disclosed herein can be implemented in electronic hardware, computer software, or a combination thereof. To clearly illustrate the interchangeability of hardware and software, the components and steps of the examples have been described generally in terms of function in the above description. Whether these functions are performed in hardware or software depends on the particular application and design constraints of the technical solution. Those skilled in the art may use different methods to implement the described functions for each particular application, but such implementations should not be considered as going beyond the scope of the present disclosure.

The steps of the methods or algorithms described in conjunction with the embodiments disclosed herein may be implemented directly with hardware, a software module executed by a processor, or a combination thereof. A software module may be placed in random access memory (RAM), memory, read-only memory (ROM), electrically programmable ROM, electrically erasable programmable ROM, a register, a hard disk, a removable diskette, a CD-ROM, or any other form of storage medium known in the art.

Finally, it should also be noted that relationship terms such as first and second, etc. are used herein only to distinguish one entity or operation from another without necessarily requiring or implying any such actual relationship or order between those entities or operations. Moreover, the terms “comprise”, “include” or any other variation thereof, are intended to cover a non-exclusive inclusion, such that a process, a method, an article, or an apparatus comprising a list of elements includes not only those elements, but also other elements not explicitly listed or may include elements inherent to the process, method, article, or apparatus. Without further limitation, an element defined by the statement of “comprising a . . .” does not exclude the further presence of additionally identical elements in a process, a method, an article or an apparatus comprising said element.

A sampling method and related device for quantum neural network structure optimization are described in detail in the present disclosure. Specific examples are used herein to illustrate the principles and embodiments of the present disclosure, and the above description of the examples is merely intended to aid in the understanding of the methods of the present disclosure and the core concepts thereof. It should be noted that those skilled in the art can make several improvements and modifications to the present disclosure without departing from the principles of the present disclosure, and these improvements and modifications also fall within the protection scope of the claims of the present disclosure.

What is claimed is:

1. A sampling method for quantum neural network structure optimization, comprising the steps of:
initializing structural parameters and constraint vectors of a quantum computer;
sampling in the constraint vector according to the constraint vector and a constraint rule to construct a quantum gate sublayer;
constructing a single-layer quantum neural network structure according to the quantum gate sublayer until the number of the single-layer quantum neural network structure layers reaches a specified value to form a quantum neural network structure; and
outputting the quantum neural network structure.

2. The method according to claim 1, wherein the step of initializing structural parameters and constraint vectors of a quantum computer comprises:
initializing the number of quantum bit, a list of feasible CNOT gates, and an initial quantum state; and
initializing constraint vectors.

3. The method according to claim 2, wherein the step of initializing constraint vectors comprises:
initializing permission vectors of a Pauli Y revolving gate;
initializing permission vectors of a Pauli Z revolving gate; and
initializing permission vectors of a CNOT gate.

4. The method according to claim 3, wherein the step of constructing a single-layer quantum neural network structure according to the quantum gate sublayer until the number of the single-layer quantum neural network structure layers reaches a specified value to form a quantum neural network structure comprises:
constructing a single-layer quantum neural network structure according to the quantum gate sublayer; and
updating the constraint vector after each single-layer quantum neural network structure is constructed, so as to update the quantum gate sublayer in a next computation round according to the updated constraint vector, and to construct a next single-layer quantum neural network structure according to the updated quantum gate sublayer until the number of the single-layer quantum neural network structure layers reaches a specified value to form a quantum neural network structure.

5. The method according to claim 4, wherein the step of sampling in the constraint vector according to the constraint vector and a constraint rule to construct a quantum gate sublayer comprises:
sampling according to the permission vectors of a Pauli Y revolving gate and the permission vectors of a Pauli Z revolving gate, to construct a single-bit gate sublayer;
updating the permission vectors of a CNOT gate according to the single-bit gate sublayer;
sampling according to the updated permission vectors of a CNOT gate to construct a CNOT gate sublayer;
the step of constructing a single-layer quantum neural network structure according to the quantum gate sublayer comprises:
constructing a single-layer quantum neural network structure according to the single-bit gate sublayer and the CNOT gate sublayer.

6. The method according to claim 5, wherein the step of updating the constraint vector after each single-layer quantum neural network structure is constructed comprises:
updating the permission vectors of a Pauli Y revolving gate, the permission vectors of a Pauli Z revolving gate, and the permission vectors of a CNOT gate after each single-layer quantum neural network structure is constructed.

7. The method according to claim 4, wherein the step of initializing structural parameters and constraint vectors of a quantum computer comprises:
initializing a resultant quantum neural network structure as an empty list;
after sampling in the constraint vector according to the constraint vector and a constraint rule to construct a quantum gate sublayer, the step further comprises:
adding the constructed single-layer quantum neural network structure to the resultant quantum neural network structure;
the step of outputting the quantum neural network structure comprises:
outputting the resultant quantum neural network structure.

8. A sampling device for quantum neural network structure optimization, comprising:
an initialization module for initializing structural parameters and constraint vectors of a quantum computer;
a quantum gate sublayer module for sampling in the constraint vector according to the constraint vector and a constraint rule to construct a quantum gate sublayer;
a single-layer quantum neural network structure module for constructing a single-layer quantum neural network structure according to the quantum gate sublayer until the number of the single-layer quantum neural network structure layers reaches a specified value to form a quantum neural network structure; and
an output module for outputting the quantum neural network structure.

9. A sampling apparatus for quantum neural network structure optimization, comprising:
a memory for storing computer program; and
a processor for implementing the steps of a sampling method for quantum neural network structure optimization according to claim 1 when executing the computer program.

10. A computer-readable storage medium, wherein the computer-readable storage medium has a computer program stored thereon, the computer program being executed by a processor to implement the steps of a sampling method for quantum neural network structure optimization according to claim 1.
